(19) United States
(12) Patent Application Publication
(10) Pub. No.: US 2025/0037448 A1
(43) Pub. Date: Jan. 30, 2025

(54) METHOD AND A SYSTEM FOR TRAINING A FOUNDATION MODEL

(71) Applicant: Robert Bosch GmbH, Stuttgart (DE)

(72) Inventors: Lavdim Halilaj, Leonberg (DE); Sebastian Monka, Stuttgart (DE)

(21) Appl. No.: 18/775,325

(22) Filed: Jul. 17, 2024

(30) Foreign Application Priority Data
Jul. 27, 2023 (DE) 102023207207.6

(51) Int. Cl. G06V 10/82

(52) U.S. Cl. CPC G06V 10/82

(57) ABSTRACT

A method for training a foundation model and/or a graph-based neural network. The method includes: providing at least one image and/or video file having image information from at least one domain and at least one image label; providing at least one general knowledge graph having information about the at least one domain; providing at least one textual description of image information of the at least one image and/or video datum; embedding the at least one textual description in the graph-based neural network using a large language model; embedding the general knowledge graph in the graph-based neural network; generating a graph-text feature vector by the graph-based neural network as a function of the at least one textual description and the general knowledge graph; generating an image feature vector by the foundation model; training the foundation model or the graph-based neural network.

### FIELD

The present invention relates to a method and a system for training a foundation model. Furthermore, the present invention relates to a method for classifying and/or categorizing and/or segmenting image and/or video data along with a computer program with program code and a computer-readable data carrier.

### BACKGROUND INFORMATION

Advances in the field of machine learning have led to many developments in artificial intelligence, particularly in the field of visual perception. One aspect of this development is the ability of neural networks to generate visual embeddings. A visual embedding is a compact representation of a visual input that enables a computer to understand visual information and act based on it.

In this context, the foundation model or base model has proven to be an effective method for generating visual embeddings based on a linguistic embedding. The foundation model uses a deep neural network (DNN) that is trained to detect the semantic meaning of a text description and generate a corresponding visual representation.

The use of DNNs enables the foundation model to learn complex relationships between linguistic and visual information and to convert high-dimensional visual data into a low-dimensional representation. As a result, it is possible to process visual information more efficiently and use it in other applications such as image recognition, video analysis or even in the development of autonomous robots.

Training a foundation model usually requires large amounts of annotated data, with which visual inputs are linked to corresponding text descriptions. By learning from this data, the model can develop a general ability to generate visual embeddings, which can be applied to a wide range of tasks. The known training methods still have potential for optimization.

From the scientific paper “Learning Visual Models using a Knowledge Graph as a Trainer,” arxiv.org/pdf/2103.00020.pdf, a method for training deep neural networks with semantic knowledge graphs/ontologies is known.

From the scientific paper “Radford, A., Kim, J. W., Hallacy, C., Ramesh, A., Goh, G., Agarwal, S., Sastry, G., Askell, A., Mishkin, P., Clark, J., Krueger, G., & Sutskever, I. (n.d.), Learning Transferable Visual Models From Natural Language Supervision,” a general method that uses a foundation model (German: Basismodell) using text and images is learned. This involves training a foundation model with a deep neural network (DNN) in order to generate a visual embedding based on a linguistic embedding given by the text description. However, it is challenging to create balanced and/or descriptive image descriptions, in particular with small amounts of data with regard to the image and/or video data.

From the scientific paper “Santurkar, S., Dubois, Y., Taori, R., Liang, P., & Hashimoto, T. (2022). Is a Caption Worth a Thousand Images? A Controlled Study for Representation Learning. arxiv.org/abs/2207.07635,” the importance of a degree of description of captions of image and/or video data, in particular with low data volumes, is known.

Approaches such as Radford et al. learn robust base models by using descriptive captions. These labels are then converted into latent vectors, i.e., word embeddings, with the aid of language models. The embeddings are subsequently used to control the learning process of the foundation models. Both the text corpus and the images are crawled from the web.

In scenarios with low data volumes, such as road sign recognition, there are no detailed labels for each sign in the publicly available text corpora. Furthermore, the conventional fine-tuning method with the standard cross-entropy loses a large part of the generalization power of the foundation model.

Fine-tuning with manually created labels also involves a large amount of manual work without a relevant underlying scheme. This can be difficult and error-prone, especially with very specific domains.

Furthermore, a deep neural network (DNN) or foundation model usually forms a visual embedding based only on the distribution of the data. Data distributions always change when a DNN is used in the real world. In foundation models, this context is provided by unstructured descriptions for each image. It can be seen that the context provided by the descriptions helps the foundation model to generalize to multiple regions. However, the availability of such a context from such descriptions is only partially available on the Internet.

An object to the present invention is to provide an improved method for training a foundation model. Another object is to provided an improved trained foundation model.

The object may be achieved by a method for training a foundation model according to features of the present invention. The object may be achieved by a system for training a foundation model according to features of the present invention. The object may further be achieved by a method for classifying and/or categorizing and/or segmenting image and/or video data according to features of present invention.

### SUMMARY

In the present invention, according to a first aspect, a method for training a foundation model, in particular a deep neural network, DNN, and/or a graph-based neural network is provided. According to an example embodiment of the present invention, the method includes the following steps:
Providing at least one image and/or video file having image information of at least one domain and at least one image label;
Providing at least one general knowledge graph, GKG, having information about the at least one domain;
Providing at least one textual description of image information of the at least one image and/or video datum;
Embedding the at least one textual description in the graph-based neural network, GNN, by means of a large language model, LLM;
Embedding the general knowledge graph in the graph-based neural network;
Generating a graph-text feature vector by the graph-based neural network as a function of the at least one textual description and, in particular, an information content from the general knowledge graph;
Generating an image feature vector by the foundation model, in particular in the form of a visual embedding in an embedding space;
Training the foundation model on the basis of the graph-text feature vector; or
Training the graph-based neural network on the basis of the embedded textual description, in particular the information content of the embedded general knowledge graph and as a function of the image feature vector; and training the foundation model on the basis of the graph-text feature vector and in particular an image information content of the at least one image and/or video datum; and
Providing the trained foundation model and/or the trained graph-based neural network.

It is understood that the steps according to the present invention as well as other optional steps do not necessarily have to be carried out in the order shown, but can also be carried out in a different order. Other intermediate steps can also be provided. The individual steps can also comprise one or more sub-steps without departing from the scope of the method according to the present invention.

Due to the present application of a general knowledge graph, in particular a domain-specific general knowledge graph, which preferably follows an underlying ontology, it is possible to generate highly descriptive image and/or video descriptions for domain-specific image and/or video data. With the aid of a meaningful and/or extensive and/or comprehensive description of the domain by a general knowledge graph, in the present application it is possible to train the foundation model in a more efficient way. In particular, the foundation model can be better adapted to new and/or changing regions and/or situations of a domain, wherein existing training data in the form of image and/or video data can still be used. The model performance of the foundation model trained in this way as a result is improved compared to the related art.

In the present application, a method for training a foundation model, which can be described in particular by a deep neural network, by means of, in particular, semantic knowledge graphs/ontologies, is described. In particular, contrastive methods between the embedding of knowledge graphs and the embedding of neural networks are described. In particular, the fine-tuning of foundation models with domain-specific content is examined, wherein the class-specific information is extracted from the knowledge graph, in particular in the form of RDF molecules. It is particularly preferable to generate a sentence for each molecule. This is then used as input for a large language model (abbr.: LLM).

In the present application, a visual foundation model is refined in order to adapt it to new domains and/or new domain parameters and/or domain information.

The present method according to the present invention also relates to the adaptation of a reduction algorithm, in particular a polynomial reduction algorithm, for utilizing word size shifts, which are in particular adapted and/or adaptable to a word size of a predetermined computer hardware. Based on this, the technical effect of an efficient hardware implementation of the algorithm or foundation model can be achieved.

Preferably, according to an example embodiment of the present invention, foundation models learn image embeddings by adapting them to embeddings of unstructured text descriptions. Instead of collecting images from the Internet, in the present application, graph-based metadata are preferably used to supplement the image and/or video data. This metadata can, for example, result from the regions of autonomous driving and/or production and/or the Internet of Things. In the present application, this domain-specific metadata are transformed into a structured format of a general knowledge graph. In principle, it is possible to supplement missing information with a suitable reasoning method. The metadata structured in this way is then preferably combined with text embeddings or the at least one textual description, in order to be usable as a context for the image and/or video data. With this approach, it is possible to train more robust and/or controlled base models or foundation models, in particular for domains with a graph-based context.

Graph-based metadata are often collected on a large scale, e.g., in cars via a CAN bus, on an assembly line in a production facility and/or in IoT devices. Since this metadata are usually graph-based, the additional graph-based use of information can improve the training of foundation models compared to the prior art.

In particular, the inclusion of prior knowledge in the form of a GKG helps to train foundation models that can be better generalized to real-life applications. The GKG adds valuable domain knowledge about the combination of heterogeneous metadata along with the possibility to interact with the data. The enriched context can then be used to train the base model or foundation model in order to use it for image matching.

“Image labeling,” also known as labeling, refers to a process of assigning at least one category and/or tag to visual data, such as images and/or videos. The label or designation is preferably a description or tag that identifies and characterizes specific features, objects or classes in an image. The goal of image labeling is preferably to understand and categorize the visual content in order to train machine systems to interpret visual information and make automated decisions. By labeling images, computer models can learn to recognize and distinguish objects, scenes, activities or certain visual features. Image labeling can take various forms, depending on what information is required. For example, individual objects can be given specific labels in order to identify them in a scene. Furthermore, attributes such as colors, shapes or texture features can also be annotated. In some cases, spatial information such as the position or extent of the objects in the image is also detected. Image labeling is often performed by human annotators who have visual understanding and domain knowledge. They analyze the image material and assign the corresponding labels. These annotations then serve as the basis for training machine learning models that learn to recognize visual patterns and are able to analyze and classify new, unannotated images.

A “general knowledge graph” is preferably a structured database that contains knowledge and/or information about a wide range of domains or topics. The general knowledge graph preferably contains domain-specific information. It is preferably a semantic network that represents information in the form of graphs by linking entities (e.g., people, places, events) with their attributes and relationships. By organizing knowledge in the form of a general knowledge graph, it is preferably possible to model and understand complex relationships and/or dependencies between different entities. The graph makes it possible to ask questions, explore relationships, analyze connections and/or derive new knowledge. The general knowledge graph is preferably used by AI systems and search engines in order to provide a more comprehensive and contextual response to user queries. By linking and evaluating information from the knowledge graph, AI systems can develop a deeper understanding of texts, questions and queries and generate more precise and relevant answers.

A “large language model,” LLM, refers to a powerful and/or extensive AI model that is trained to generate human-like texts, answer questions, conduct dialogs and/or communicate in natural language. It is based on machine learning techniques, particularly in the field of deep learning. A large language model preferably uses a deep neural network with a large number of parameters in order to achieve a high degree of complexity and/or flexibility in language processing. These models are preferably trained on extensive text corpora taken from books, articles, websites and other written sources. The training of a large language model is preferably effected by applying self-supervised learning, where the model learns from the text data, preferably without the need for specific annotations or human intervention. Due to the exposure to a large amount of text, the model can learn complex language patterns, grammar rules, semantic meanings and contextual dependencies. In the present application, all sentences generated on the basis of the sub-graph, together with their labels, serve as an input text corpora for learning word or sentence embeddings using such a large language model. BERT or GPT, for example, can be used as a large language model. A standalone LLM is also conceivable, in particular for sensitive domain information.

A “foundation model” refers to a basic model or a basic set of techniques that serve as a starting point for the development of more advanced models and/or applications. With regard to machine learning and artificial intelligence, a foundation model usually refers to a basic neural network and/or architecture that is suitable for a wide range of tasks or applications. It is preferably used as a starting point for training more specialized models that are tailored to specific domains or tasks. A foundation model can preferably be trained with extensive training data and deep learning methods in order to develop a basic understanding of patterns, features and relationships in the data. It is preferably used as the basis for learning general properties and/or features and can serve as a basis for extracting features, classifying data, generating texts or other tasks. Particularly preferably, in the present application a fine-tuning of the foundation model is effected with the previously calculated word/sentence embeddings, which are independent of the image data. The foundation model is trained by the input of the image and/or video data and on the basis of the monitoring of the word/sentence embeddings. The foundation model preferably comprises a deep neural network with a transformer model structure.

A graph neural network is a machine learning model that works on graph structures. It is used in order to analyze patterns and relationships in data organized as graphs. GNNs have applications in areas such as social network analysis, recommendation systems and computer graphics.

In the present application, a generic knowledge graph (GKG) is therefore preferably provided and/or created and/or used, in particular on the basis of (automatically) collected metadata for each image and/or video datum. Furthermore, a text embedding of a textual description is preferably effected via a large language model (LLM). This embedding is preferably done together with the embedding of an information content of the GKG via the GNN. The foundation model or deep neural network (DNN) is preferably trained by adapting its visual embedding to the graph-text feature vector with the aid of a contrastive loss value. The training of the DNN is preferably effected using the calculated graph-text feature vector, which is particularly independent of the image and/or video data. Alternatively, the training of the DNN and GNN are effected together. The graph-text feature vector is preferably trained with the input/information content of the GKG and the textual description and monitoring of the image embedding (visual embedding) of the DNN. The DNN is preferably trained with the input of the image and/or video data and monitoring by the graph-text feature vector.

In a preferred example embodiment of the present invention, the at least one general knowledge graph is provided on the basis of metadata about a domain, wherein further information preferably is added by means of reasoning. Further information can be added by means of reasoning. This means that logical conclusions and inference methods are used in order to derive or generate additional information from the existing data in the general knowledge graph. As a result, the general knowledge graph is to be made more comprehensive and meaningful.

In a preferred example embodiment of the present invention, the at least one general knowledge graph is provided from domain knowledge that is described in particular by a domain expert and/or from information that is extracted from the at least one image and/or video datum.

In a preferred example embodiment of the present invention, the at least one textual description comprises at least one sentence in natural language that is generated based on an information content of the general knowledge graph. The textual description thus preferably comprises at least one statement and/or a semantic context of meaning that is comprised in a text that is formulated in a language understandable to humans.

In a preferred example embodiment of the present invention, the large language model comprises a GPT-LLM and/or a BERT-LLM. In principle, other LLMs are also conceivable, so that the list is not to be understood as restrictive.

In a preferred example embodiment of the present invention, the at least one image and/or video datum is detected by at least one optical sensor, in particular a camera and/or a lidar sensor and/or a radar sensor and/or an ultrasonic sensor. In principle, other sensors and/or sensor data are also conceivable, as long as they can be processed by the foundation model and/or converted into a data feature vector and/or described in text form using natural language.

In a preferred example embodiment of the present invention, the at least one image and/or video datum is generated by data augmentation from existing image and/or video data. Data augmentation refers to a technique in machine learning with which new data points are artificially generated by transforming and/or modifying existing data. The aim of data augmentation is to increase the amount and variety of available training data in order to improve the performance and robustness of machine learning models. Various transformations can be applied during data augmentation, depending on the type of data and the requirements of the model. In the field of image processing, operations such as cropping, scaling, rotating, mirroring or adding noise can be used in particular in order to generate new images that differ slightly from the original data.

In a preferred example embodiment of the present invention, the providing of at least one textual description of image information of the at least one image and/or video datum comprises extracting a sub-graph from the general knowledge graph as a function of the at least one image label by means of RDF molecule extraction. RDF molecule extraction preferably refers to the process of identifying and/or extracting RDF molecules from unstructured or semi-structured data sources, such as a general knowledge graph. RDF preferably stands for resource description framework, a flexible data model for representing information in the form of triples (subject-predicate-object), which can be interpreted as statements or facts. RDF molecule extraction attempts to identify specific statements and/or facts from a text corpus and/or data source and convert them into RDF structures. This process can take place at different levels, from the extraction of single triples to the identification of complex molecules consisting of a series of connected triples. RDF molecules are preferably extracted from the general knowledge graph in the form of sub-graphs that contain information specific to road signs, for example. A corresponding sentence is preferably generated for each RDF molecule. A “sub-graph” or molecule of a general knowledge graph preferably refers to a section or subset of the entire knowledge graph. It is preferably a delimited region having certain entities, attributes and/or relationships that are preferably connected to one another and/or represent a specific field of knowledge and/or a specific domain. In the present application, the framework of the method can be used to extract relevant knowledge about a domain in the form of at least one sub-graph, in particular a so-called RDF molecule, from a general knowledge graph (GKG). These “molecules” are preferably transformed into natural language sentences and general latent vector representations (language embeddings) using a large language model (LLM). Subsequently, the foundation model, which is preferably represented by a deep neural network, is trained to adapt a visual embedding from the at least one image and/or video datum to the language embeddings generated by the general knowledge graph in the form of the natural language sentences.

In a preferred example embodiment of the present invention, the training of the foundation model and/or the graph-based neural network is effected on the basis of a loss value that can be calculated from the graph-text feature vector and the image feature vector, in particular by successive and/or iterative minimization of the loss value. The foundation model is preferably trained in order to establish a relationship between sentence feature vectors and image feature vectors. The sentence feature vector preferably represents the linguistic properties and/or information, while the image feature vector preferably describes the visual properties and/or information. The foundation model preferably learns how well the sentence feature vector and/or the image feature vector match and/or how well they are correlated. The training is preferably based on a loss function that quantifies the difference and/or deviation between the sentence feature vector and the image feature vector. The goal is preferably to minimize this loss value in order to optimize the agreement or correlation between the two feature vectors. The preferred embodiment of the training process comprises the step-by-step or iterative minimization of the loss value. This means that the foundation model is trained in successive iterations and/or steps, wherein the loss value should be further reduced at each step. This iterative approach enables the foundation model to continuously improve and detect the feature relationships more effectively. The same applies to the graph-based neural network.

In a preferred example embodiment of the present invention, a production line comprising the device assembly for generating specifiable products is further provided. A production line is preferably a sequence of production stations and/or work areas arranged so that they work together to produce at least one product. This production line can comprise various devices, machines and/or equipment configured for the production of the specified products. In this embodiment, it is emphasized that in the preferred embodiment, a specific device assembly is present in the production line. This device assembly could comprise, in particular, machines, robots, automated assembly lines, tools and/or other devices necessary for the production of the specified products.

In a preferred example embodiment of the present invention, after providing the production line, the method further comprises the following step: Generating at least one specifiable product using the device assembly. According to this embodiment, after the production line has been provided, a method is performed which aims to produce at least one specifiable product. This step is effected using the existing device assembly in the production line. In the present application, it is not specified in more detail what type of product it is or what the exact production process looks like. The emphasis is on the fact that in the preferred embodiment, the method aims to generate at least one specifiable product in the production line with the aid of the provided device assembly.

In the present application, according to a second aspect, a system for training a foundation model according to the present invention is disclosed herein. According to an example embodiment of the present invention, the system has: a provisioning device that is designed to provide at least one image and/or video datum having image information of at least one domain and at least one image label; at least one general knowledge graph, GKG, having information about the at least one domain, and at least one textual description of image information of the at least one image and/or video datum; and an evaluation and computing device that is designed to embed the at least one textual description in the graph-based neural network, GNN, by means of a large-language model, LLM; to embed the general knowledge graph in the graph-based neural network; to generate a graph-text feature vector by the graph-based neural network as a function of the at least one textual description and the general knowledge graph; to generate an image feature vector by the foundation model, in particular in the form of a visual embedding in an embedding space; to train the foundation model on the basis of the graph-text feature vector; or to train the graph-based neural network on the basis of the embedded textual description, the embedded general knowledge graph and as a function of the image feature vector and the foundation model on the basis of the graph-text feature vector and the at least one image and/or video datum;
wherein the provisioning device is further configured to provide the trained foundation model and/or the trained graph-based neural network.

In the present application, according to a third aspect, a method for classifying and/or categorizing and/or segmenting image and/or video data according to the present invention is disclosed. According to an example embodiment of the present invention, the method has the following steps: Providing a foundation model trained by the present method; providing at least one, in particular labeled, image and/or video datum; converting the at least one image and/or video datum into at least one image feature vector by the trained foundation model; and classifying and/or categorizing and/or segmenting the at least one image and/or video datum as a function of the image feature vector by a trained machine learning classification and/or categorization and/or segmentation algorithm, in particular by a trained Gaussian model and/or linear model.

According to an example embodiment of the present invention, during the inference of the foundation model trained in the present application, a classification and/or categorization and/or segmentation of domain-specific image and/or video data is preferably effected. This can be effected with the aid of a Gaussian process or a linear model. Preferably, so-called Gaussians, in particular having at least one mean value and/or a covariance matrix, are adapted for each class. The adaptation is preferably effected based on the samples for the training data, in particular in the visual embedding space. Alternatively, a linear layer or multilayer perceptron (abbr.: MLP) can be trained on the trained embedding space of the foundation model. An MLP consists of three main types of layers: Input layer, hidden layers and output layer. The input layer receives the input data that is transferred to the network. The hidden layers are intermediate layers that lie between the input layer and the output layer. The output layer provides the predictions or classification results of the network.

The present method according to the present invention or the resulting trained foundation model of the present invention can be used to analyze (image and/or video) data obtained from a sensor. In the present application, the term “image and/or video data” can also be replaced by “sensor data”. The sensor can ascertain measurements of the surrounding area in the form of sensor signals, which can be provided by the following elements, for example: digital images, e.g., video, radar, LiDAR, ultrasound, movement, thermal images, audio signals and/or specific data, such as 1D data (e.g., in production). In principle, it is also possible to obtain information about elements encoded by the sensor signal based on a sensor signal. In other words, an indirect measurement can be performed based on a sensor signal used as a direct measurement. This is also known as virtual sensor technology. Furthermore, the present method or the trained foundation model resulting therefrom can be used to classify and/or categorize and/or segment the sensor data, in particular to recognize the presence or absence of objects in the sensor data and/or to undertake a semantic segmentation of the sensor data, e.g., with respect to traffic signs and/or road surfaces and/or pedestrians and/or vehicles and/or other. The present method or the resulting trained foundation model can also be used to determine a continuous value or multiple continuous values, i.e., to perform a regression analysis, e.g., with respect to a distance and/or a velocity and/or an acceleration and/or a tracking of an element, e.g., an object, in the data. This method and the resulting trained foundation model can be used to recognize anomalies in a technical system. For example, Gaussian deviations and/or other uncertainty values can be used in order to recognize anomalies.

For example, it must be ensured that an automated vehicle does not collide with pedestrians. Based on the semantic segmentation, a computer calculates depth information of all pedestrians present in an image space, calculates a trajectory around these pedestrians and controls the autonomously driving vehicle so that it follows this trajectory so closely that it does not hit any pedestrians. In principle, this also applies to any mobile robot in order to avoid people who could be in its path and/or out of its path of movement. The foundation model trained according to the invention can be used effectively for this purpose.

Furthermore, the foundation model trained according to the present invention can also be used in combination with a regression algorithm in order to ascertain a precise spatial orientation of the vehicle, in particular using data from yaw rate and/or linear acceleration sensors of a vehicle.

In the present application, a control device is also particularly preferably provided according to the present invention, which is comprised in an autonomous vehicle and/or a robotic system and/or an industrial machine, and on which the present method of the present invention according to the first aspect or the third aspect is at least partially executable.

Due to the present active learning training method, a foundation model can also be provided according to the present invention, which can learn to ascertain at which operating point of an engine an exhaust emission of the engine is to be tested. The engine is preferably operated at this operating point, the exhaust emissions are measured and entered into the actively learning foundation model as input data until the model is deemed good enough.

In an automated vehicle, the algorithm described here, in particular the active learning algorithm or the foundation model according to the present invention, preferably defines predetermined scenarios for which image and/or video data and/or data from alternative sensors are to be collected. The image and/or video data detected by the corresponding at least one sensor of the vehicle is preferably analyzed by the trained foundation model, and the scenario represented in the image and/or video data is classified (e.g., by recognizing and/or classifying objects in the image and/or video data. If the scenario represented corresponds to a predetermined scenario, the corresponding image and/or video datum is preferably transferred to a back-end computer, which in particular collects such image and/or video data from a large number of vehicles and uses this image and/or video data to actively (re) train the foundation model or a machine learning system, e.g., an image classifier, which is preferably updated continuously and/or cyclically and/or at intervals in the automated vehicle.

In a networked physical system, e.g., a networked automated vehicle, an anomaly detector can also be used to recognize whether a selected frame of predefined length (e.g., 5 s) from an accelerometer time series has an anomaly. If this is the case, this frame is transmitted to a back-end computer, where it can be used, e.g., to define corner cases for checking the ML system, according to the result of which the connected physical system is operated.

In the present application, a computer program comprising program code is also provided according to the present invention, in order to perform at least parts of the method according to the first aspect or the third aspect of the present invention, in each case in one of its embodiments, when the computer program is executed on a computer. In other words, according to the invention, a computer program (product) comprising commands that, when the program is executed by a computer, cause the computer to carry out the method/steps of the method according to the present invention in any of its embodiments.

In the present application, a computer-readable data carrier having program code of a computer program is also provided according to the present invention, in order to perform at least parts of the method according to the first aspect or the third aspect of the present invention, in each case in one of its embodiments, when the computer program is executed on a computer. In other words, the present invention relates to a computer-readable (memory) medium comprising instructions which, when executed by a computer, cause the computer to perform the method/steps of the method according to the present invention in one of its embodiments.

The described embodiments and developments of the present invention can be combined with one another as desired.

Further possible embodiments, developments and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the embodiments of the present invention. They illustrate example embodiments and, in the context of the description, serve to explain principles and concepts of the present invention.

Other embodiments and many of the mentioned advantages are apparent from the figures. The illustrated elements of the drawings are not necessarily shown to scale relative to one another.

FIG. 1 shows a schematic flow chart of an example embodiment of the present method for training a foundation model, according the present invention.

FIG. 2 shows a schematic block diagram of an example embodiment of the present method for training a foundation model, according to the present invention.

In the figures, identical reference signs denote identical or functionally identical elements, parts of components, unless stated otherwise.

### DETAILED DESCRIPTION OF EXAMPLE EMBODIMENTS

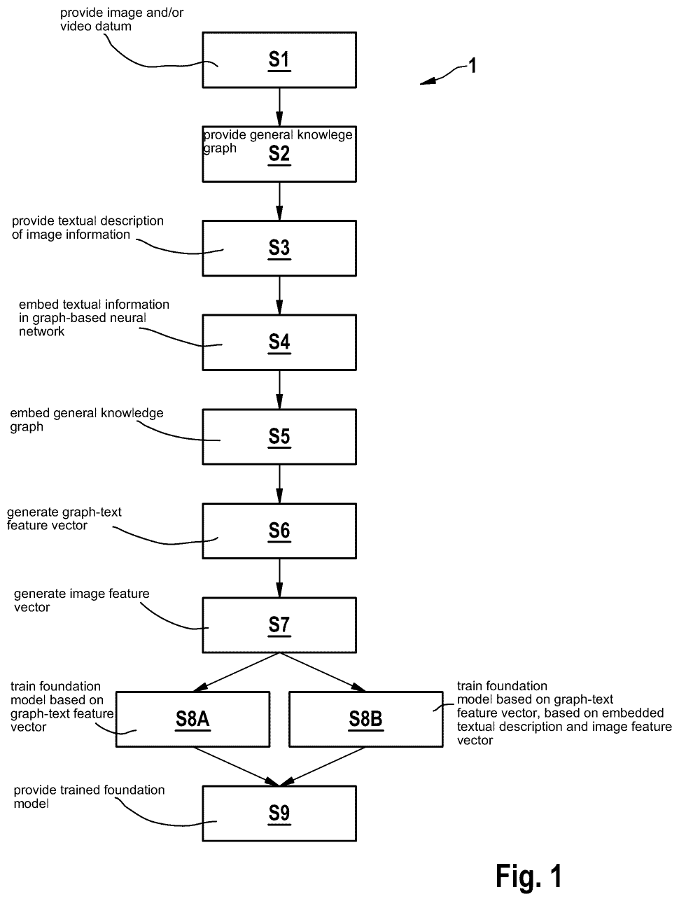

FIG. 1 shows a schematic flow chart of a method for training a foundation model.

In any embodiment, the method can be carried out at least in part by a system 1, which for this purpose can comprise multiple components not shown in more detail, for example one or more provisioning devices and/or at least one evaluation and computing device. It is self-evident that the provision unit can be designed together with the evaluation and computing unit, or can be different therefrom. Furthermore, the system can comprise a storage device and/or an output device and/or a display device and/or an input device.

According to the invention, the computer-implemented method comprises at least the following steps:

In a step S1, a provision of at least one image and/or video datum having image information of at least one domain and at least one image label is effected. The at least one image and/or video datum is detected, for example, by at least one optical sensor. Alternatively or additionally, the at least one image and/or video datum is generated by data augmentation from existing image and/or video data.

In a step S2, a provision of at least one general knowledge graph, GKG, having information about the at least one domain is effected. The at least one general knowledge graph is preferably provided from domain knowledge, which is described in particular by a domain expert, and/or from information extracted from the at least one image and/or video datum. The at least one general knowledge graph is preferably provided on the basis of metadata about a domain, wherein further information is preferably added by means of reasoning.

In a step S3, a provision of at least one textual description of image information of the at least one image and/or video datum is effected.

In a step S4, an embedding of at least one textual description in the graph-based neural network, GNN, is effected by means of a large language model, LLM.

In step S5, an embedding of the general knowledge graph in the graph-based neural network is effected.

In a step S6, a generation of a graph-text feature vector by the graph-based neural network is effected as a function of the at least one textual description and the general knowledge graph.

In a step S7, a generation of an image feature vector is effected by the foundation model, in particular in the form of a visual embedding in an embedding space.

In step S8A, a training of the foundation model is effected on the basis of the graph-text feature vector.

Alternatively, (step S8B) a training of the graph-based neural network can be effected on the basis of the embedded textual description, the embedded general knowledge graph and as a function of the image feature vector; and a training of the foundation model can be effected on the basis of the graph-text feature vector and the at least one image and/or video datum.

In step S9, the trained foundation model 200 and/or the trained graph-based neural network 202 are provided.

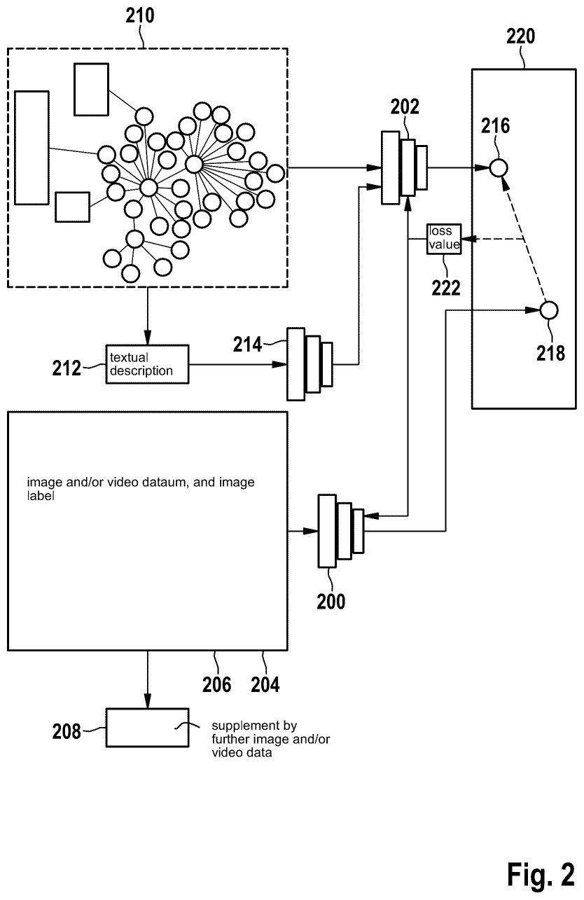

FIG. 2 shows a schematic block diagram of an exemplary embodiment of the present method for training a foundation model 200 and/or a graph-based neural network 202. At least one image and/or video datum 204 is provided, which has image information of at least one domain and at least one image label 206. The at least one image and/or video datum 204 can preferably be supplemented by further image and/or video data by means of data augmentation 208. At least one general knowledge graph 210 is provided, which has information about the at least one domain. The general knowledge graph 210 is preferably based on meta information that is automatically collected about the domain. Based on the general knowledge graph 210, at least one textual description 212 of image information of the at least one image and/or video datum 204 is preferably provided. It is also possible to generate further descriptions from the at least one textual description 212 via data or text augmentation. The at least one textual description 212 is embedded in the graph-based neural network 202 by means of a large language model 214. The large language model 214 can be GPT-3, for example. An information content of the general knowledge graph 210 is embedded in the graph-based neural network 202. The graph-based neural network 202 generates a graph-text feature vector 216 as a function of the at least one textual description 212 and an information content of the general knowledge graph 210. The foundation model 200 generates an image feature vector 218, in particular in the form of a visual embedding in an embedding space 220. For example, the foundation model 200 is trained on the basis of the graph-text feature vector 216. Alternatively, the graph-based neural network 202 can be trained on the basis of the embedded textual description 212, the embedded information content from the general knowledge graph 210 and as a function of the image feature vector 218 together with the foundation model 200, wherein the foundation model 200 is trained on the basis of the graph-text feature vector 216 and an image content of the at least one image and/or video datum 204.

The training S8A, S8B of the foundation model 200 and/or the graph-based neural network 202 is effected on the basis of a loss value 222 that can be calculated from the graph-text feature vector 216 and the image feature vector 218, in particular by successively and/or iteratively minimizing the loss value 222.

1-15. (canceled)

16. A method for training a foundation model including a deep neural network and/or a graph-based neural network, the method comprising the following steps:
providing at least one image and/or video datum including image information of at least one domain and at least one image label;
providing at least one general knowledge graph including information about the at least one domain;
providing at least one textual description of image information of the at least one image and/or video datum;
embedding the at least one textual description in the graph-based neural network using a large language model;
embedding the general knowledge graph in the graph-based neural network;
generating a graph-text feature vector by the graph-based neural network as a function of the at least one textual description and the general knowledge graph;
generating an image feature vector by the foundation model;
(i) training the foundation model based on the graph-text feature vector, or (ii) training the graph-based neural network based on the embedded textual description, the embedded general knowledge graph, and as a function of the image feature vector, and training the foundation model based on the graph-text feature vector and the at least one image and/or video datum; and
providing the trained foundation model and/or the trained graph-based neural network.

17. The method according to claim 16, wherein the at least one general knowledge graph is based on metadata about a domain, wherein further information is added using reasoning.

18. The method according to claim 16, wherein the at least one general knowledge graph is provided: (i) from domain knowledge that is described by a domain expert and/or (ii) from information that is extracted from the at least one image and/or video datum.

19. The method according to claim 16, wherein the at least one textual description has at least one sentence in natural language that is generated based on an information content of the general knowledge graph.

20. The method according to claim 16, wherein the large language model has a GPT-LLM and/or a BERT-LLM.

21. The method according to claim 16, wherein the at least one image and/or video datum is detected by at least one optical sensor.

22. The method according to claim 16, wherein the at least one image and/or video datum is generated by data augmentation from existing image data and/or existing video data.

23. The method according to claim 16, wherein the providing of the at least one textual description of image information of the at least one image and/or video datum includes extracting a sub-graph from the general knowledge graph as a function of the at least one image label using RDF molecule extraction.

24. The method according to claim 16, wherein the training of the foundation model and/or the graph-based neural network is effected based on a loss value that can be calculated from the graph-text feature vector and the image feature vector, by successively and/or iteratively minimizing the loss value.

25. The method according to claim 16, wherein a production line including a device assembly for generating specifiable products is provided.

26. The method according to claim 25, further comprising: after providing the production line, generating at least one specifiable product using the device assembly.

27. A system configured to train a foundation model including a deep neural network and/or a graph-based neural network, the system comprising:
a provisioning device configured to provide at least one image and/or video datum having image information of at least one domain and at least one image label, at least one general knowledge graph including having information about the at least one domain, and at least one textual description of image information of the at least one image and/or video datum; and
an evaluation and computing device that is configured: (i) to embed the at least one textual description in the graph-based neural network, using a large language model; to embed the general knowledge graph in the graph-based neural network, (iii) to generate a graph-text feature vector by the graph-based neural network as a function of the at least one textual description and the general knowledge graph, (iv) to generate an image feature vector by the foundation model, and (v) to train the foundation model based on the graph-text feature vector; or to train the graph-based neural network based on the embedded textual description, the embedded general knowledge graph and as a function of the image feature vector and the foundation model based on the graph-text feature vector and the at least one image and/or video datum;
wherein the provisioning device is further configured to provide the trained foundation model and/or the trained graph-based neural network.

28. A method for classifying and/or categorizing and/or segmenting image and/or video data, the method comprising the steps:
providing a foundation model trained by:
providing at least one image and/or video datum including image information of at least one domain and at least one image label,
providing at least one general knowledge graph including information about the at least one domain,
providing at least one textual description of image information of the at least one image and/or video datum,
embedding the at least one textual description in the graph-based neural network using a large language model,
embedding the general knowledge graph in the graph-based neural network,
generating a graph-text feature vector by the graph-based neural network as a function of the at least one textual description and the general knowledge graph,
generating an image feature vector by the foundation model,
(i) training the foundation model based on the graph-text feature vector, or (ii) training the graph-based neural network based on the embedded textual description, the embedded general knowledge graph, and as a function of the image feature vector, and training the foundation model based on the graph-text feature vector and the at least one image and/or video datum, and
providing the trained foundation model and/or the trained graph-based neural network;
providing at least one labeled image and/or labeled video datum;
converting the at least one labeled image and/or labeled video datum into at least one image feature vector by the trained foundation model; and
classifying and/or categorizing and/or segmenting the at least one labeled image and/or labeled video datum as a function of the image feature vector by a trained machine learning classification and/or categorization and/or segmentation algorithm.

29. A non-transitory computer-readable data carrier having program code of a computer program for training a foundation model including a deep neural network and/or a graph-based neural network, the program code, when executed by a computer, causing the computer to perform the following steps:
providing at least one image and/or video datum including image information of at least one domain and at least one image label;
providing at least one general knowledge graph including information about the at least one domain;
providing at least one textual description of image information of the at least one image and/or video datum;
embedding the at least one textual description in the graph-based neural network using a large language model;
embedding the general knowledge graph in the graph-based neural network;
generating a graph-text feature vector by the graph-based neural network as a function of the at least one textual description and the general knowledge graph;
generating an image feature vector by the foundation model;
(i) training the foundation model based on the graph-text feature vector, or (ii) training the graph-based neural network based on the embedded textual description, the embedded general knowledge graph, and as a function of the image feature vector, and training the foundation model based on the graph-text feature vector and the at least one image and/or video datum; and
providing the trained foundation model and/or the trained graph-based neural network.
